(19) United States
(12) Patent Application Publication
(10) Pub. No.: US 2005/0001573 A1
(43) Pub. Date: Jan. 6, 2005

(54) Non-contact safety system

(76) Inventors: Bearge Miller, Glen Mills, PA (US); Norman K. Miller, Glen Mills, PA (US); Michael Anderson, Lititz, PA (US); Kenneth Mowrer, Landenberg, PA (US); Timothy Castello, West Chester, PA (US); Gary Leigh, Kennett Square, PA (US); Raymond Sipple, Brookhaven, PA (US)

Correspondence Address: LAW OFFICES OF MARK A. GARZIA, P.C., 2058 CHICHESTER AVE, BOOTHWYN, PA, 19061, US

(21) Appl. No.: 10/607,636

(22) Filed: Jun. 27, 2003

Related U.S. Application Data
(60) Provisional application No. 60/393,180, filed on Jul. 1, 2002.

(51) Int. Cl. H02P 7/00

(52) U.S. Cl. 318/445

(57) ABSTRACT

The present invention discloses a non-contact door safety system comprising two spring-loaded legs on either side of the door and a photo-optic system that creates a beam the desired distance in front of the leading edge of the door. The beam can be considered an imaginary leading edge of the door.

### CROSS REFERENCE TO RELATED APPLICATIONS

The present application claims the benefits under 35 U.S.C. § 19(e) of U.S. Provisional Application No. 60/393,180 filed Jul. 1, 2002, entitled NON-CONTACT SAFETY SYSTEM in the name of Bearge Miller, Norman K. Miller, Michael Anderson, Kenneth Mowrer, Timothy Castello, Gary Leigh, and Raymond Sipple.

U.S. Provisional Application No. 60/393,180, filed Jul. 1, 2002, is hereby incorporated by reference as if fully set forth herein.

### FIELD OF THE INVENTION

The present invention relates to a safety system for an automatic door or gate and, more particularly, to a non-contact switch and related circuitry for use in such a safety system.

### BACKGROUND OF THE INVENTION

Automatic doors that are opened and closed by an electric motor are well-known. It is desirable to have a safety system that stops or reverses the direction of travel of the door when an object is in the path of travel of the door.

Safety systems that utilize contact or pressure-activated switches located on the leading edge of an automatic door are also known in the industry. For example, U.S. Pat. No. 6,396,010 to Woodward et al. discloses a safety edge switch that extends longitudinally along the entire length of the leading edge of the door. The edge switch consists of an electrode array having a plurality of spaced apart electrically conductive bridging members. The edge switch is normally in the closed figuration. When the leading edge of the door (and thus the edge switch) engages an object, the conductive bridging members separate, thereby breaking electrical contact (in effect opening the switch) and sending a signal back to the motor that controls the door. When the motor receives this signal it reverses the direction of travel of the door.

Many of the edge or sensing switches that have been developed prior to the present invention rely on flexible covers and deformable foam located inside the flexible material. Over time, and because many doors are located outside, the weather and elements take its toll on the flexible material and the foam. In the aforementioned patent to Woodward, the switch is normally closed. If water is allowed to seep inside or if there is a deterioration of the outer flexible housing, the switch will stay closed even when the door engages an object. If the switch cannot open, no signal can be sent to the motor to reverse the direction of travel of the door which would negate the purpose of having a safety system.

Other safety systems have utilized an electric eye (i.e., light beam) system. The electric eye system is fixedly mounted on the tracks of the overhead door; a transmitter is positioned on one track while a receiver is positioned on the other track. A control circuit is usually positioned next to the door. The transmitter and receiver are located just inches off the floor.

A beam of light is transmitted from the transmitter to the receiver. If the beam of light is interrupted (e.g., by a person walking or placing an object in the beam), the control circuit senses the interruption and sends a signal to turn the motor off or to reverse the direction of travel of the motor, thereby stopping the door from hitting the person or object that broke the beam Some drawbacks of an electric eye system are that the transmitter and receiver are exposed. Because of the position of the transmitter and receiver proximate the ground, they are easy targets to be stepped on or kicked; at the very least, the transmitter/receiver become mis-aligned and, sometimes, are damaged. Further, a person may step over the light beam or an object may straddle the light beam without interrupting it, in which case the safety system is not triggered while the person or object is still in the path of the moving door.

U.S. Pat. No. 4,984,658 to Peelle et al. discloses an optical system mounted on the door. A transmitter and a receiver are mounted on T-shaped shoes. The shoes are designed to slide in C-shaped channels. A C-shaped channel is positioned and attached on each side of the door.

In the Peelle system, the transmitter and receiver are not protected, thereby increasing the possibility that they may be bumped. Also, dirt and grime may accumulate in the exposed C-shaped channels restricting the movement of the T-shaped shoes. Finally, the length of the T-shaped shoes limit the size and type of door on which this safety system may operate. If the system is to be used for large or heavy doors, the length of the C-shaped channels and T-shaped shoes may be prohibitive because they must be long enough to compensate for the overtravel of the door. (The “overtravel” is defined as the distance the door continues to travel after the motor controlling the movement of the door receives a signal to stop or reverse direction. The overtravel is caused by the inertia of the door.)

### SUMMARY OF THE INVENTION

The present invention consists of two telescoping, spring-loaded legs—one each located along side of an automatic door. An optical sensing/detection system is located on the ends of the legs. The optical sensing system creates a light beam at a desired distance in front of the leading edge of the door. This distance is at least as great as the overtravel of the door. Before the leading edge of the door can physically engage an object, the beam is broken, a signal is sent to the controlling motor and the door either stops or reverses direction.

### BRIEF DESCRIPTION OF THE DRAWINGS

The accompanying drawings, which are incorporated in and form a part of the specification, illustrate the embodiments of the present invention and, together with the following description, serve to explain the principles of the invention. For the purpose of illustrating the invention, there are shown in the drawings embodiments which are presently preferred, it being understood, however, that the invention is not limited to the specific instrumentality or the precise arrangement of elements or process steps disclosed.

In the drawings:

FIG. 1A is a front plan view of the safety system in accordance with the present invention mounted on a overhead door;

FIG. 1B is a front plan view of the safety system illustrated in FIG. 1A with the overhead door fully closed;

FIG. 2A is a side view of a two-segment spring-loaded leg;

FIG. 2B is a fragmentary view of an adjacent side of the spring-loaded leg illustrated in FIG. 2A;

FIG. 3A is a side view of the three-segment spring-loaded leg;

FIG. 3B is a fragmentary view of an adjacent side of the spring-loaded leg of FIG. 3A;

FIG. 3C is a reduced scale view of the leg illustrated in FIG. 3A;

FIG. 3D is a reduced scale view of the leg illustrated in FIG. 3B;

FIG. 4A is a side view of a three-segment spring-loaded leg in accordance with another embodiment of the present invention;

FIG. 4B is a fragmentary view of an adjacent side of the leg illustrated in FIG. 4A;

FIG. 5 is a flowchart of the general operations performed by the control circuit;

FIG. 6 is an alternate embodiment adapted for use with elevator doors; and

FIG. 7 is an alternate embodiment adapted for use with a gate.

### DETAILED DESCRIPTION OF THE PREFERRED EMBODIMENT

In describing a preferred embodiment of the invention, specific terminology will be selected for the sake of clarity. However, the invention is not intended to be limited to the specific terms so selected, and it is to be understood that each specific term includes all technical equivalents that operate in a similar manner to accomplish a similar purpose.

Preferred embodiments of the present invention will now be described in detail with reference to the accompanying drawings in which the non-contact safety edge system in accordance with the present invention is generally indicated at 10.

The present invention is designed to be used with various automatic doors and gates and is adaptable so that it may be used with almost any automatic door or gate currently sold.

In an automatic door 90, an electric motor 92 communicates with the door via a chain or wire rope. When the motor rotates in one direction, the door moves to a fully closed position; when the motor rotates in the opposite direction, the door moves to a fully open position. The motor 92 may include a switch to stop its rotation thereby stopping the door at a position somewhere between its fully open and fully closed positions.

It is known to connect a safety system to the motor 92 that drives the door. The motor 92 either stops or reverses direction when it receives a signal from a switch or other safety circuit that senses an object in the path of travel of the door.

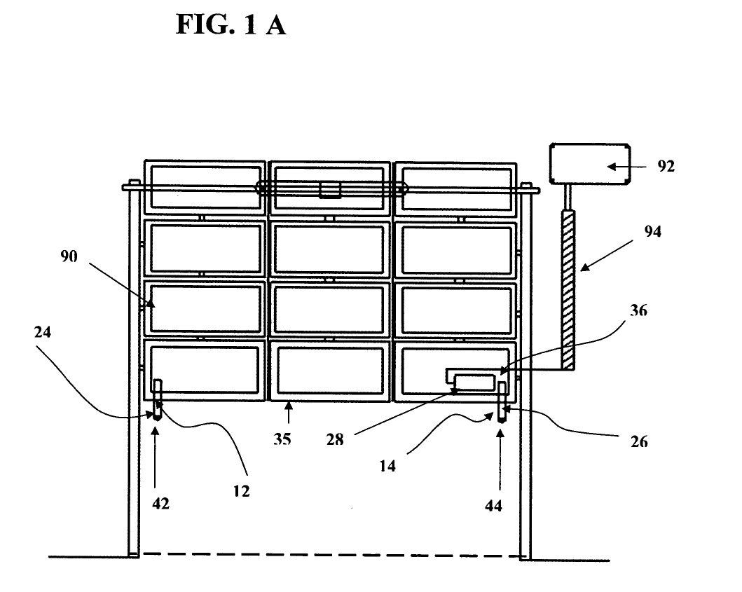

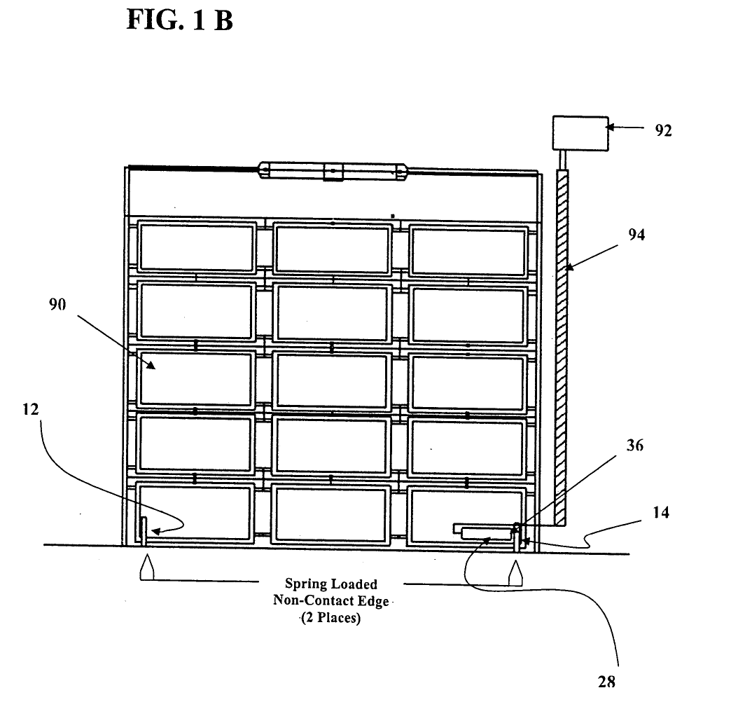

Referring to FIGS. 1A and 1B, the non-contact safety edge system 10 is illustrated in connection with a typical overhead door 90. (In these drawings, the view is looking at the overhead door from the inside of the building.) First spring-loaded leg 12 is attached on the left side of the overhead door 90 and second spring-loaded leg 14 is attached to the right side of the door 90. It will be apparent to those skilled in the art, after reading this detailed description, that the first and second legs may be mounted on either side of the door to accommodate a particular door or situation.

As illustrated in FIG. 1A, both legs are in their fully extended position when the door 90 is fully open or partially open. When the door 90 is completely closed (i.e., the leading edge of the door engages the floor, as shown in FIG. 1B) the spring-loaded legs 12, 14 are fully retracted. Depending on the actual length of the spring-loaded legs 12, 14, the type and size of door, and the proximity of the door to the floor, the spring-loaded legs may be partially extended when the door 90 is completely closed.

As illustrated, the extension of the spring-loaded legs are substantially equal as the door moves through its entire cycle. This allows the length of the first leg 12 to remain equal to the length of the second leg 14, throughout the entire travel of the overhead door 90. That is, the tip 42 of the first leg remains at the same distance in front of the leading edge of the door 90 as the tip 44 of the second leg—even if the legs are partially or fully retracted.

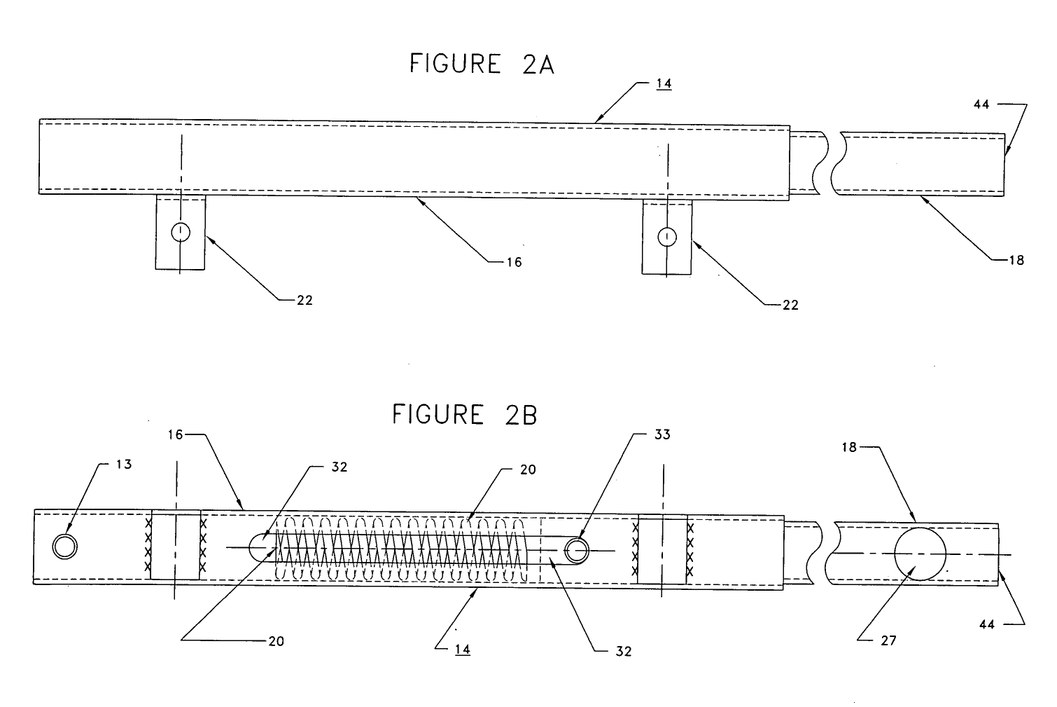

Referring now to FIGS. 2A and 2B, further details of the legs are shown. FIGS. 2A and 2B illustrate a two-segment leg. (The right leg 14 is actually illustrated, the left leg 12 being a mirror image.)

The legs 12, 14 comprise a primary tube 16 and a secondary tube 18. In one embodiment, both tubes 16, 18 have a square cross-section; however, it would be clear to those skilled in the art that the shape of the tube is not particularly important and tubes having a circular, rectangular or other shaped cross-section may be used.

The outer dimension of the secondary tube 18 is slightly smaller than the inner dimension of the primary tube 16. This allows the secondary tube 18 to slide into and out of the primary tube 16 and gives the legs a telescopic ability. As the automatic door 90 rises, the secondary tube 18 relies, at least partially, on gravity to extend outward from the primary tube 16 to achieve its full length.

Slot 32 in primary tube 16 communicates with pin 33 that is attached to secondary tube 18. This pin/slot arrangement sets the minimum and maximum travel distance of secondary tube 18 with respect to primary tube 16.

A compression spring 20 is located within the primary tube 16 and is of sufficient diameter that it does not enter the secondary tube 18 but can abut the end of the secondary tube 18. The opposite end of the compression spring 20 engages a pin 13. The compression spring 20 applies a positive pressure on the secondary tube 18 as it retracts and extends. The compression spring 20 needs only to be long enough to engage pin 13 and the end of secondary tube 18 when the door is completely closed and the legs 12, 14 are fully retracted.

It is a feature of this invention that the secondary tube 18 is protected by the primary tube 16. This ensures that the leg operation is smooth, resistant to dirt and other particles and virtually maintenance free. Although gravity is the primary force for keeping the legs extended and aligned, the spring(s) play an important role.

Over time, especially in industrial applications, dirt may accumulate on the secondary tube 18 and it may not slide as easily into primary tube 16. If dirt does accumulate on the secondary tubes 18, the springs ensure the operation of the telescoping legs by applying an initial force to move the retracted legs into their extended position.

The secondary tube 18 includes means 27 for mounting an optical system proximate the ends of each leg. The optical system comprises an optical transmitter 24 mounted on first leg 12, an optical receiver 26 located on second leg 14, both of which are electrically connected to an associated control circuit 28. As illustrated, the mounting means 27 is a mounting hole through the secondary leg 18. The hole allows wires to be threaded through the primary tube 16 and secondary tube 18 to be connected to the optical equipment.

Some embodiments of a spring-tensioned leg in accordance with the present invention may have a reinforced section 88 in which to mount the receiver or transmitter.

An advantage of using tubes 16, 18 for the legs is that the electrical wires may be run through the middle of the legs to connect the transmitter 24 and the receiver 26 to the control circuit 28. Also, the wires may be run through the interior of the compression springs 20 if desired. A more elaborate mounting means (including brackets, rubber holders, etc.) may be used when required.

In another embodiment, the optical transmitter and the optical receiver are both mounted on the first leg while a mirror is mounted on the second leg.

The primary tube 16 is fitted with brackets 22 as illustrated in FIG. 2A, for attaching the legs to the sides of the door 90. (The brackets 22 may take the form of L-shaped pieces as shown, or rectangular bars having multiple mounting holes or slots to allow for more flexibility in attaching the leg to the door).

A feature of the present invention is that the mounting of the legs to the door is simple and inexpensive. Usually, a ruler and a screwdriver are the only tools needed to mount the legs (and sometimes not even a ruler is required). The simplicity of the mounting means virtually eliminates the need for aligning the receiver 26 with the transmitter 28.

Hatch marks may be placed on both leg assemblies to help with aligning the transmitter/receiver (or the tip of the legs). The hatch marks may be etched into the outer surface of the legl assemblies or may be decals.

It may be desirable to cap the tips 44 of each leg with a plastic or rubber cap (not shown) to prevent damage to the floor as the legs engage the floor. The caps may also prevent damage or scratches to an object that is struck by a leg as the door descends.

Referring again to FIGS. 1A and 1B, the control circuit 28 is shown mounted on the door 90. A coiled wire 94 provides the low power voltage to operate the control circuit 28, the transmitter 28 and the receiver 26; the coiled wire also provides the electrical connection to allow the safety system to control the operation of the motor 92.

The optical transmitter sends a light beam (preferably infrared) to the optical receiver. Depending on the length of the legs (i.e., the combined length of primary tube 16 and secondary tube 18), the light beam will precede the actual leading edge of the door 90 by a pre-determined distance. In the preferred embodiment, the predetermined distance is slightly longer than the overtravel of the door.

The light beam forms a constructive leading edge in front of the physical leading edge of the door. When an object breaks the light beam, the optical receiver 26 sends a signal to the control circuit which sends the appropriate signal to the motor 92 that controls movement of the door 90. Depending on the situation, the motor 92 will then either stop immediately or reverse direction, thereby preventing the leading edge of the door from contacting the object. Note that even if the motor stops immediately, the inertia of the door will keep the door moving a certain distance (i.e., the overtravel).

In many industrial applications, the door is large and heavy. Once it begins moving, it has a relatively long overtravel when compared to smaller, lighter doors.

FIGS. 2A and 2B illustrate the basic operation of a two-segment telescoping leg. When the door 90 is open, gravity affects the secondary tubes 18 such that they are extended out from the primary tubes 16. As the door closes and approaches the floor 95, the tips 44 of the secondary tubes 18 engage the floor and the secondary tubes 18 retract inside the primary tubes 16. Spring 20 provides the initial pressure to move the secondary tube 18 out from primary tube 16. The springs and gravity continue acting on the secondary tubes until they are completely extended. This ensures the smooth deployment of secondary tubes 18 thereby ensuring that the optical transmitter in the first leg 12 remains aligned with the optical receiver in the second leg 14.

Another feature of this invention is that the telescoping legs are not limited to two segments or sections. A three-segment, four segment, etc. telescoping leg can easily be developed. Each segment of the leg will have its own spring associated therewith. As explained previously, the springs ensure the smooth operation of each leg segment helping ensure that the ends of the legs (and thus the light beam) are always the same distance in front of the door.

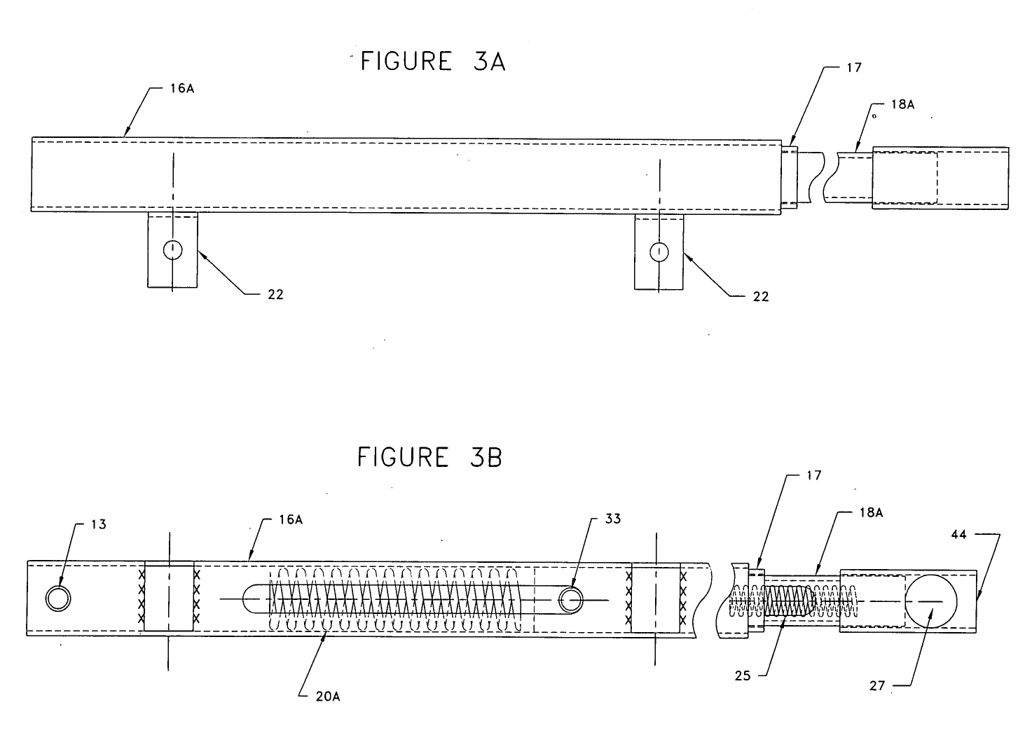

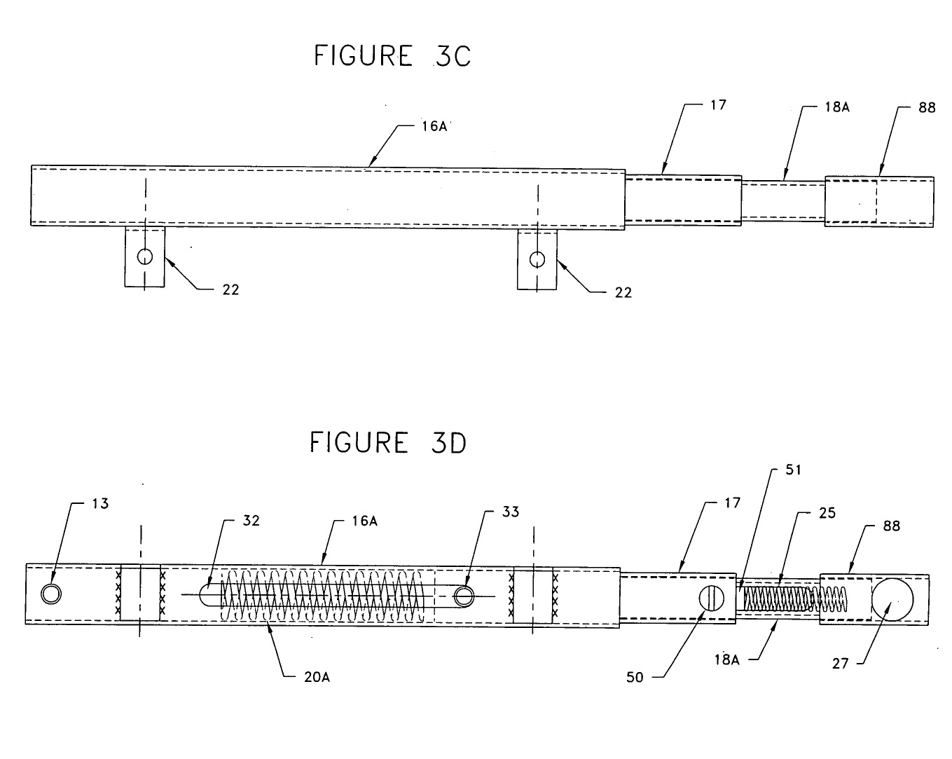

A preferred embodiment utilizing three segments for each leg, is illustrated in FIGS. 3A-3D. In a three-segment leg, a middle tube 17 and a secondary tube 18A telescopically nest within primary tube 16A. A first compression spring 20A ensures that middle tube 17 extends properly and a second compression spring 25 mounted within secondary tube 18A ensures that secondary tube 18A extends properly. As illustrated in FIG. 3D, the second compression spring 25 is squeezed between the interior end of secondary tube 18A and set screw 50. Set screw 50 communicates with slot 51 in secondary tube 18A and has a length almost the entire diameter of secondary tube 18A.

Set screw 50 serves two purposes; first, it determines the maximum travel of secondary tube 18A (in conjunction with slot 51; and second, it provides a stop for compression spring 25.

Similar to a two-segment telescoping leg, the tubes 16A, 17 in a three-segment telescoping leg also act (i.e., extend) under the pull of gravity; however the springs 20A, 25 also apply positive pressure on the telescoping tubes.

A feature of the present invention is that the legs 12, 14 are designed sufficiently long to compensate for the overtravel of almost any door. If the overtravel of the door 90 is twelve inches, the tips 44 of both legs 12, 14 should be the same distance in front of the leading edge of the door and, in this example, this distance should be greater than twelve inches when the door 90 is completely or partially opened. Therefore, in this example, a virtual leading edge would be created about thirteen inches in front of the actual leading edge. Only when the leading edge of the door comes within twelve inches of the floor will the legs 12, 14 start to retract; however, the legs will retract in unison so that the tips of the legs will always remain the same distance before the leading edge of the door and the IR beam will not be broken as the legs retract (unless an object breaks the beam).

By designing the leg to have multiple segments, the physical profile of each leg (i.e., the primary tube 16) may be reduced. In one embodiment, it is desired to keep the primary tube 16 under eight inches in length. However, a three-segment leg may reach almost twenty-four inches when fully extended (i.e., primary tube 16A is eight inches long, and middle tube 17 and the secondary tube 18A are both approximately eight inches in length). This feature is important when considering the overtravel of the door. Since this safety system was designed to be used in industrial applications as well as residential applications, one size (e.g., an eight inch primary tube 16A) will fit a majority of applications.

Similar to the function of the springs in a two-segment leg, an advantage of using compression springs is that if dirt accumulates on the primary surfaces of the telescoping tubes 17, 18A, the springs provide positive actuation to ensure that the legs extend and retract in unison.

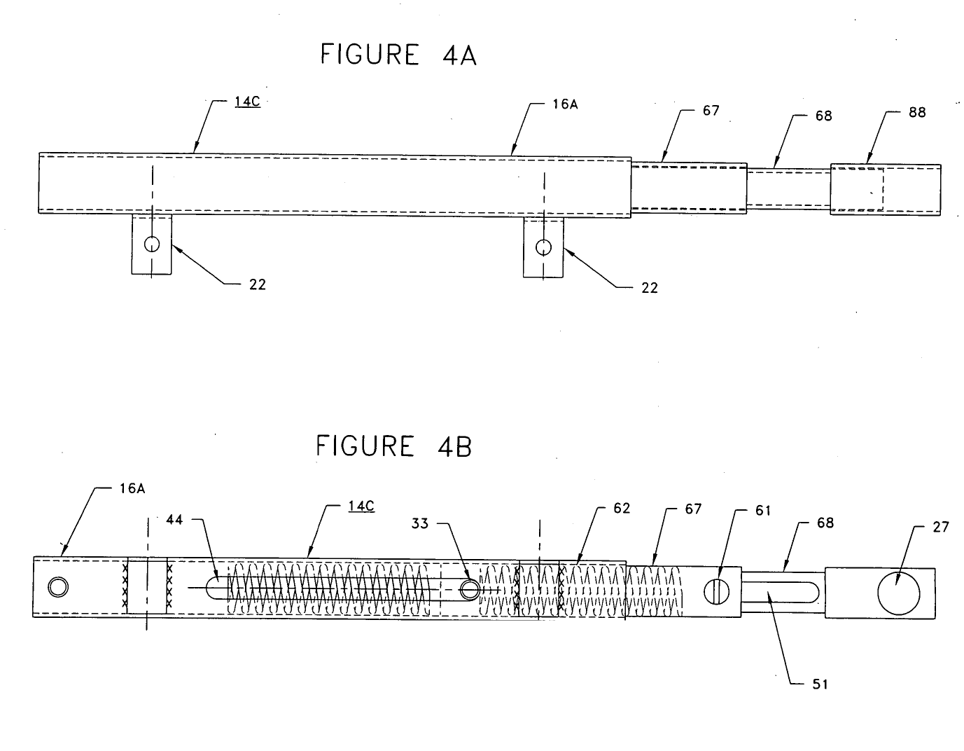

Another embodiment of a three-segmented leg in accordance with the present invention is illustrated in FIGS. 4A and 4B. This embodiment of the leg is similar to the three-segment leg illustrated in FIGS. 3A and 3B. The receiver or transmitter is secured to opening 27. The middle tube 67 and the secondary tube 68 telescopically slide inside primary tube 16A. Compression spring 20A abuts the end of middle tube 67. Pin 33 is attached to middle tube 67. Slot 44 in primary tube 16A works in conjunction with pin 33 to guide middle tube 67. The operation of middle tube 67, pin 33, slot 44 and primary tube 16A is similar to corresponding elements illustrated in FIGS. 2A, 2B and 3A through 3D.

Compression spring 62 is located within middle tube 67. When leg 14C is compressed, compression spring 62 abuts against pin 33 and the top of secondary tube 68.

Screw guide 61 communicates with slot 51 to limit the travel of secondary tube 68. However, screw guide 61 does not extend the diameter of secondary tube 68 but only enough to guide and prevent secondary tube 68 from sliding completely out of middle tube 67. In this manner, secondary tube 68 may be easily removed for maintenance, repair, cleaning, or exchange by removing one relatively short screw, namely screw guide 61.

Since the secondary tubes 68 are the smallest in diameter, they would tend to wear out quicker than the larger diameter primary tubes 16A. Repair and/or exchange of a secondary tube 68 is a simple matter of loosening one screw (i.e., screw guide 61), throwing the old or damaged secondary tube away, inserting a new tube and tightening the screw.

The control circuit 28 for the optical system may be mounted on the door (as illustrated in FIGS. 1A and 1B) or on the wall proximate the door opening. The control circuit 28 is connected to the automatic door motor 92 via wire 94, connected to the transmitter 24 via wire 35, and connected to the receiver 26 via wire 36. In a preferred embodiment, the wire 94 connecting the motor 92 to the control circuit 28 is coiled to allow the wire to contract when the control circuit 28 is close to the motor and to let the wire uncoil and stretch while the control circuit 28 moves farther away from the motor. When the light beam that extends between the transmitter and the receiver is interrupted, the control circuit 28 receives a signal from the receiver; the control circuit in turn sends a signal to the motor thereby stopping the motor or reversing the motor's direction (depending on how the system is set up).

There are a number of commercially available control systems that may be used in the present invention. However, it is desirable to have a control system that reduces EMF and IR noise that may accidentally trigger the control system especially in an industrial application. In particular, the present control system helps to reduce the number of incidents involving false positives and to increase the sensitivity of the safety system.

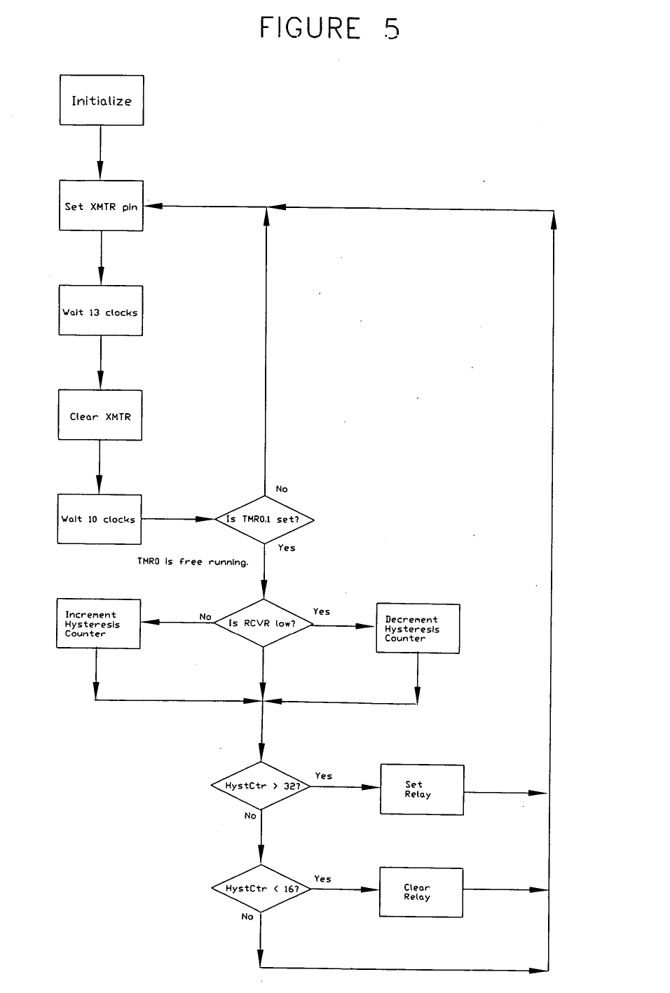

FIG. 5 is a flow chart indicating generally the commands carried out by a control circuit in accordance with the present invention. Upon startup, the control circuit is initialized. Signals are sent to the transmitter to set then to clear the transmitter. Once the transmitter is cleared, an infrared beam is sent by the transmitter to the receiver. The transmitter periodically transmits a train of pulses. The train consists of a pre-determined number of pulses. The pulse frequency must be fairly precise. The receiver responds by pulling the signal line low for the duration of the pulse train. A microprocessor checks to see if the signal line is low, if so a counter is decremented. If the pulse train is not detected (because of a system fault or because the IR beam has been occluded) the microprocessor increments a counter. Above a certain threshold, the microprocessor treats the event as an actual object in the path of the IR beam.

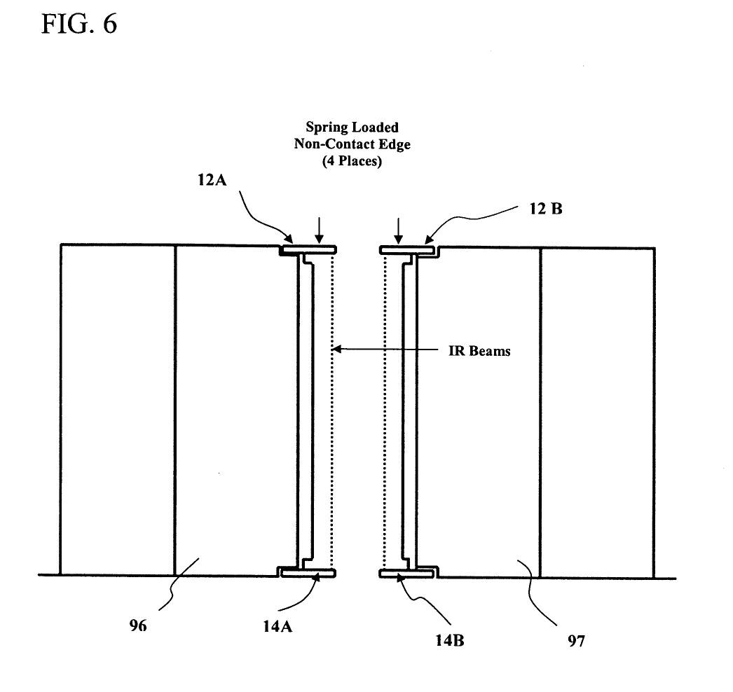

FIG. 6 is an alternative arrangement of the present system 10 used in connection with horizontally-moving doors as in an elevator. First door 96 and second door 97 each have their own non-contact safety system 10. A pair of first legs 12A, 12B and a pair of second legs 14A, 14B are attached to the top and bottom of each door.

As illustrated in FIG. 6, the length of the legs account for the overtravel of each door. The IR beams are positioned in front of the physical leading edge of the door by at least the distance of the overtravel of the door.

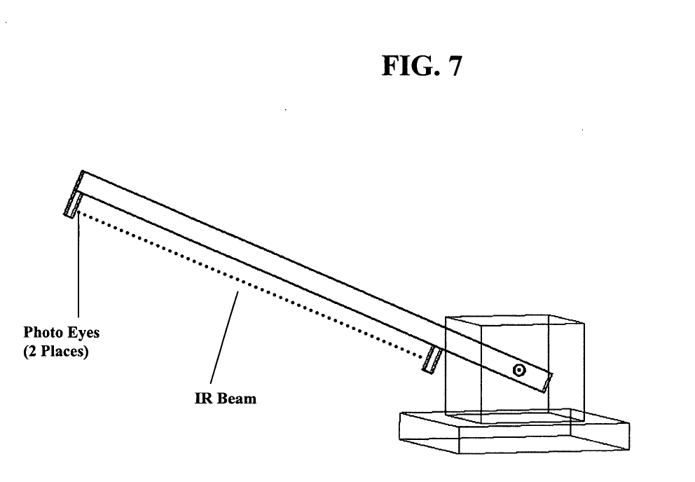

FIG. 7 is an alternative arrangement of the present system 10 used in connection with a vertical lift gate. If an object breaks the IR beam, the gate raises.

In most embodiments, the legs of the present invention are made of steel or aluminum. However, it would be evident to one skilled in the art, after reading this description, to replace certain elements with plastic, Teflon® or graphite parts. For example, by making secondary tube 68 out of plastic (see FIGS. 4A and 4B), the manufacturing cost of each leg may be reduced. The selection of materials may also affect the sensitivity of the telescoping tubes. For example, Teflon or graphite tubes may more easily slide into and out of each other.

Although the leg assemblies are shown with the largest dimensioned tubes secured to the door, the transmitter/receiver attached to the smallest dimensioned tube, with the smaller dimensioned tubes moving into and out of the larger tubes, it may be desirable to have the smallest dimensioned tube connected to the door while the transmitter and receiver are attached to the largest dimensioned tubes (i.e., upside down from the leg assemblies illustrated in the attached Figures). For example, the smallest tube will be fitted with brackets 22 allowing the smallest tube to be attached to the door; the brackets may then also act as a stop to limit the telescopic nesting or distance the larger tubes slide over the smaller tubes.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

1. A safety system for controlling the movement of an automatically operated overhead door, the automatic overhead door including an overhead door that moves in a vertical direction and that rides in two tracks on either side of the door, an electric motor, means for connecting the motor to the door so that when the motor turns in one direction the door lowers, and when the motor turns in the opposite direction, the door rises, and a control system for starting and stopping the motor thereby controlling movement of the door, the safety system comprising:
a pair of spring-loaded leg assemblies mounted on either side of the door near the door's leading edge;
each leg assembly has an outer tube and at least one inner tube having an exterior dimension smaller than the interior dimension of the outer tube so that the inner tube can be telescopically inserted into the outer tube;
a spring mounted inside the tubes to apply an outward axial force between the tubes;
an optical transmitter mounted on the inner-most tube of one leg;
an optical receiver mounted on the inner-most tube of the other leg, said optical transmitter sending an optical beam to the optical receiver;
sensing circuit electrically connected to at least the optical receiver for determining if the optical beam is broken, said sensing circuit connected to the control system for controlling operation of the motor.

2. The safety system of claim 1 wherein the motor is stopped which stops door, when the optical beam is broken.

3. The safety system of claim 1 wherein the motor is reversed thereby reversing travel of the door when the optical beam is broken.

4. The safety system of claim 1 wherein said leg assembly comprises one outer tube and one inner tube.

5. The safety system of claim 1 wherein said leg assembly comprises one outer tube and two inner tubes, the first inner tube having an exterior dimension that is smaller than the interior dimension of the outer tube, the second inner tube having an exterior dimension that is smaller than the interior dimension of the first inner tube thereby allowing the second inner tube to telescopically nest within said first inner tube and allowing said first inner tube to telescopically nest within said outer tube.

6. The safety system of claim 1 wherein the length of said leg assemblies are designed to hold the optical transmitter and the optical receiver at the appropriate distance in front of the leading edge of the overhead door to accommodate the over-travel of the overhead door.

7. The safety system of claim 6 wherein the length of the leg assemblies can be adjusted by changing the lengths of the tubes.

8. The safety system of claim 6 wherein the length of the leg assemblies can be adjusted by changing the number of inner tubes.

9. The safety system of claim 1 wherein the tubes have a square cross-section.

10. The safety system of claim 1 wherein the tubes have a circular cross-section.

11. The safety system of claim 1 wherein the outer tubes contain a number of hatch marks which may be used for aligning the leg assemblies.

12. The safety system of claim 1 further comprising metal tabs on the outer tube for attaching said leg assemblies to the door.

13. The safety system of claim 1 further comprising a pin and slot arrangement in the tubes to limit the nesting of the inner tubes within the outer tube.

14. A safety system comprising in combination:
an automatically operated overhead door assembly, the automatic door assembly including an overhead door that moves in a vertical direction and that rides in two tracks on either side of the door;
an electric motor;
means for connecting the motor to the door so that when the motor turns in one direction the door lowers, when the motor turns in the opposite direction the door rises, and when the motor stops the door stops; and
a control system for starting, reversing direction and stopping the motor thereby controlling movement of the door;
a pair of spring-loaded leg assemblies mounted on either side of the door near the door's leading edge;
each leg assembly has an outer tube and at least one inner tube having an exterior dimension smaller than the interior dimension of the outer tube so that the inner tube can be telescopically inserted into the outer tube;
a spring mounted inside the tubes to apply an outward axial force between the tubes telescopically tending to extend the tubes to their maximum length but allows the legs to telescopically contract when the inner tube engages the ground as the door lowers;
an optical transmitter mounted on the inner-most tube of one leg;
an optical receiver mounted on the inner-most tube of the other leg, said optical transmitter sending an optical beam to the optical receiver such that the optical beam acts as a constructive leading edge of the door;
a sensing circuit electrically connected to at least the optical receiver for determining if the constructive leading edge engages an object, said sensing circuit connected to the control system for controlling operation of the motor.

15. The safety system of claim 14 further comprising a pin and slot arrangement in the tubes to limit the nesting of the inner tubes within the outer tube.

16. The safety system of claim 15 wherein the length of the leg assemblies can be adjusted by changing the lengths of the tubes.

17. The safety system of claim 15 wherein the length of the leg assemblies can be adjusted by changing the number of inner tubes.
